(19) United States
(12) Patent Application Publication
(10) Pub. No.: US 2014/0333129 A1
(43) Pub. Date: Nov. 13, 2014

(54) SYSTEM AND METHOD FOR COMPENSATING FOR HIGH-FREQUENCY LEAKAGE CURRENTS IN A MOTOR VEHICLE

(71) Applicant: RENAULT s.a.s., Boulogne-Billancourt (FR)

(72) Inventors: Christophe Ripoll, Chevreuse (FR); Jerome Durand, Paris (FR)

(73) Assignee: RENAULT s.a.s., Boulogne-Billancourt (FR)

(21) Appl. No.: 14/365,197

(22) PCT Filed: Dec. 14, 2012
(86) PCT No.: PCT/EP2012/075506

§ 371 Date: Jun. 13, 2014

(30) Foreign Application Priority Data
Dec. 14, 2011 (FR) 1161633

(51) Int. Cl. B60L 3/00; B60L 11/18

(52) U.S. Cl. CPC B60L 3/0061; B60L 11/1809
USPC 307/10.1

(57) ABSTRACT

A system for compensating for a high-frequency leakage current emanating from at least one component of a motor vehicle, connected to a power supply network via a rectifier device, the power supply network having a ground and at least one phase other than ground. For each component, a first compensation device is connected to rectified phases originating from the rectifier device upstream of the component, and to a motor vehicle ground and/or a second compensation device is connected to rectified phases downstream of the component and to the ground, the compensation devices configured to pick off some of the voltage applied to the component and transmit to the ground a compensation current of same amplitude and direction as the leakage current but of opposite phase.

The technical field of the invention is battery charging systems, and more particularly the battery chargers installed in a motor vehicle.

The use of an uninsulated charger for recharging a battery, notably a battery of an electric vehicle, can lead to the appearance of a leakage current upon the connection to the distribution network. This leakage current passes through the exposed conductive structure and can trip the residual current differential protection devices arranged between the charger and the distribution network. When these protection devices are tripped, the charger power supply is shut down, the vehicle charging process then being stopped.

Generally, the leakage currents are limited by introducing a transformer with galvanic insulation between the network and the battery. However, the size of these transformers increases with the charging power passing through them. The battery chargers installed in the electric motor vehicles are subject to the same disadvantages and the same remedies. However, the accumulated weight/power ratio defines the range of the vehicle. It is not therefore satisfactory to increase the weight of the vehicle by including transformers with galvanic insulation in the installed charger.

Moreover, certain members of a motor vehicle can generate high-frequency leakage currents. Such is the case in particular with electric motors in which the rotor or the stator can generate such currents. These leakage currents require specific processing in order to take account of their frequency component.

There is a need for a system for neutralizing leakage currents originating from a member of a motor vehicle, the motor vehicle being connected to an electric power supply network via an uninsulated charger.

There is also a need for a neutralizing system able to neutralize high-frequency leakage currents.

According to one aspect of the invention, there is proposed a system for neutralizing high-frequency leakage currents emanating from at least one member of a motor vehicle, connected to a power supply network in an uninsulated manner via a rectifying device connected to the power supply network, the power supply network having a ground, and at least one phase different from the ground. For each member, a first neutralizing device is connected to rectified phases emanating from the rectifying device upstream of the member and to the exposed conductive structure of the motor vehicle, and/or a second neutralizing device is connected to rectified phases located downstream of the member, and to the exposed conductive structure, the neutralizing devices being able to tap a part of the voltage applied to the member and to send into the exposed conductive structure a neutralizing current of the same amplitude, of the same direction and of a phase opposite the leakage current.

Such a system presents the advantage of neutralizing the leakage currents upstream and downstream of the member originating said currents. The neutralizing device may comprise a transformer with a first winding linked on the one hand to the member, and on the other hand to a first plate of a capacitor, the other plate of the capacitor being linked to the ground. The second winding of the transformer is linked on the one hand to the ground and on the other hand to a terminal of an impedance, the other terminal of the impedance being linked to the exposed conductive structure.

The neutralizing system offers the advantage of employing a restricted number of components. The cost of producing the system is thus reduced.

The impedance of the neutralizing device can be equal to the impedance between the member and the exposed conductive structure.

A neutralizing device downstream of a first member may be common with a neutralizing device upstream of a second member.

According to another aspect of the invention, there is proposed a method for neutralizing high-frequency leakage currents emanating from at least one member of a motor vehicle, connected to a power supply network in an uninsulated manner via a rectifying device connected to the power supply network, the power supply network having a ground, and at least one phase different from the ground, in which there is generated, on the exposed conductive structure of the motor vehicle, a neutralizing current of the same amplitude, of the same direction and of a phase opposite the leakage current.

It is possible to tap a part of the voltage applied to the member, phase-shift the tapped voltage, and convert the tapped voltage into neutralizing current of the same amplitude, of the same direction and of the phase opposite the leakage current.

Other aims, features and advantages will become apparent on reading the following description, given solely as a nonlimiting example, and with reference to the attached drawings in which:

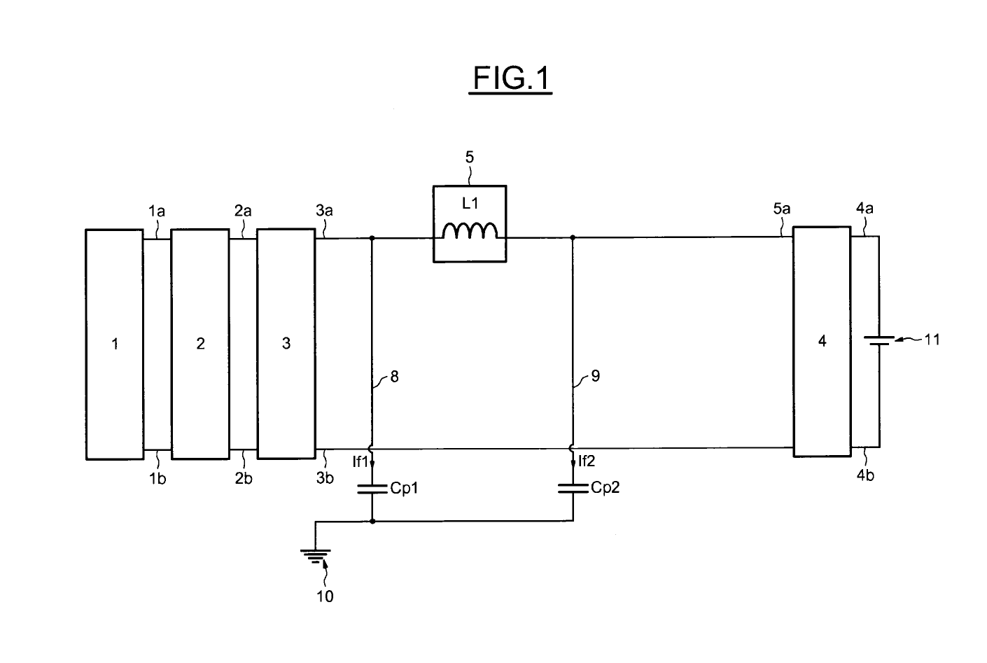

FIG. 1 illustrates an electrical network of a motor vehicle provided with an electric motor, and

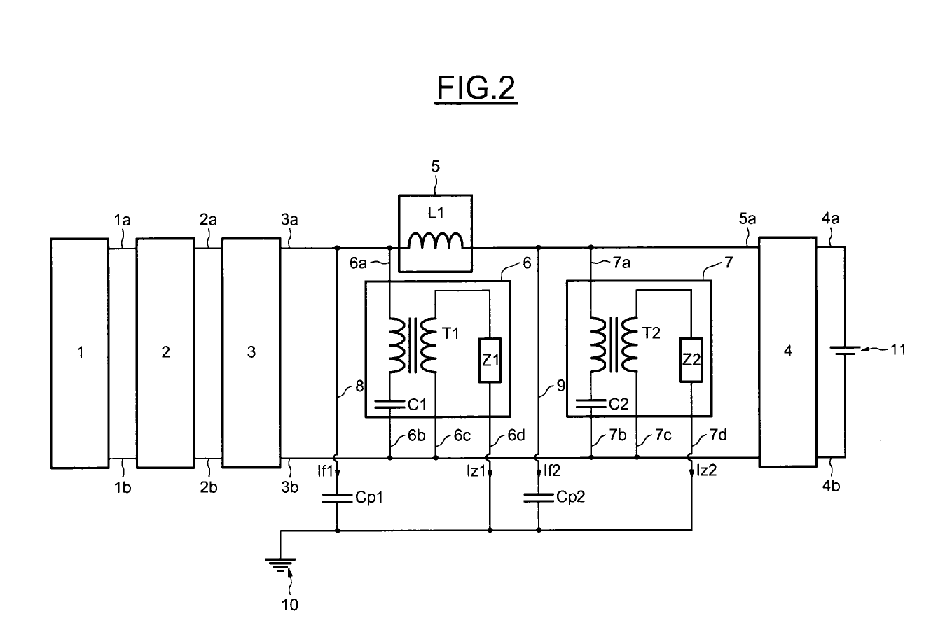

FIG. 2 illustrates a system for neutralizing leakage currents in the electrical network of a motor vehicle provided with an electric motor.

FIG. 1 shows a single-phase electrical power supply network 1 comprising a phase different from the ground linked to a connection 1a and a ground linked to a connection 1b.

The electrical power supply network 1 is linked by connections 1a, 1b to the input of a common-mode filter 2. The common-mode filter 2 is linked at the output to a rectifying device 3 via positive 2a and negative 2b connections which is itself linked at the output by a connection 3a to an electric motor 5 and by a connection 3b to an inverter 4. The rectifying device 3 may comprise chopping switches. The connection 3a may carry a high-frequency chopped voltage, generating leakage currents If1 and If2.

The electric motor 5 is linked at the output by the connection 5a to another input of the inverter 4. The inverter 4 is linked also to a battery 11 by connections 4a, 4b.

The connections 1a, 2a, 1b and 2b carry a current emanating from the phases of the electrical power supply network. The connections 3a, 3b and 5a carry a current emanating from the phases rectified by the rectifying device 3.

The electric motor 5 comprises at least one inductance L1 that is the source of leakage currents. It should be noted that the invention is illustrated here in the context of the neutralizing of leakage currents emanating from an electric motor winding. However, the invention can be applied to any electrical system that can generate leakage currents.

Returning to FIG. 1, it is noted that the leakage currents emanating from the inductance L1 are respectively denoted If1 and If2. These leakage currents appear on connections, respectively 8 and 9, between on the one hand the exposed conductive structure 10 and on the other hand the connections 3a, respectively 5a, linking the electric motor 5 to the rectified phase of the electrical distribution network 1. The common-mode coupling capacitors characterizing the leakage currents are denoted Cp1 and Cp2. The capacitor Cp1 is connected on the one hand between the rectifying device 3 and the electric motor 5 and on the other hand to the exposed conductive structure 10. The capacitor Cp2 is connected on the one hand between the inverter 4 and the electric motor 5 and on the other hand to the exposed conductive structure 10. The capacitors Cp1 and Cp2 thus characterize the leakage currents upstream and downstream of the inductance L1 of the electric motor.

In FIG. 2, the elements that are common to FIG. 1 bear the same references and provide the same functions. FIG. 2 differs from FIG. 1 by leakage current neutralizing devices 6, 7.

The first leakage current neutralizing device 6 comprises a transformer T1 with a first winding linked on the one hand between the electric motor 5 and the rectifying device 3 via a connection 6a, and on the other hand to a first plate of a capacitor C1, the other plate of the capacitor C1 being linked to the connection 3b via a connection 6b.

The second winding of the transformer T1 is linked on the one hand to the connection 3b via a connection 6c and on the other hand to a terminal of an impedance Z1, the other terminal of the impedance Z1 being linked to the exposed conductive structure 10 via a connection 6d.

The second neutralizing device 7 has a structure similar to the first neutralizing device 6.

The second leakage current neutralizing device 7 comprises a transformer T2 with a first winding linked on the one hand between the electric motor 5 and the inverter 4 by a connection 7a, and on the other hand to a first plate of a capacitor C2, the other plate of the capacitor C2 being linked to the connection 3b via a connection 7b.

The second winding of the transformer T2 is linked on the one hand to the connection 3b via a connection 7c and on the other hand to a terminal of an impedance Z2, the other terminal of the impedance Z2 being linked to the exposed conductive structure 10 via a connection 7d.

The first leakage current neutralizing device 6 makes it possible to neutralize the leakage current If1 by injecting, into the exposed conductive structure 10, a current Iz1 of the same amplitude, of the same direction but of a phase opposite the current If1.

The second leakage current neutralizing device 7 makes it possible to neutralize the leakage current If2 by injecting, into the exposed conductive structure 10, a current Iz2 of the same amplitude, of the same direction but of a phase opposite the current If2.

The leakage current neutralizing system comprising the first neutralizing device 6 and the second neutralizing device 7 thus makes it possible to neutralize all the leakage currents originating from the electric motor 5.

A neutralizing device such as those described above makes it possible to neutralize in particular the high-frequency leakage currents. The high-frequency component of the current powering the electric motor 5 is partly tapped for the generation of the neutralizing current Iz1 by the neutralizing devices 6, 7. At high frequency, the capacitors C1, C2 see their impedances tend toward zero. They then behave as short circuits. The potential difference between the connector 3a and the connector 3b generates is then at the level of the first winding of the transformers T1 or respectively T2, which in return generate a voltage proportional to the level of the second winding. This voltage at the terminals of the second winding is applied to the terminals of the impedance Z1 or respectively Z2 which gives rise to the neutralizing currents Iz1, Iz2.

By contrast, at low frequency, the capacitors see their impedances tend toward infinity. They behave like an open switch. No voltage is applied to the terminals of the primary windings, and no neutralizing current is generated.

It thus appears that the neutralizing devices 6, 7 are particularly suited to neutralizing high-frequency leakage currents.

It also appears that the common-mode capacitors Cp1 and Cp2 have to be characterized before the design of the neutralizing devices in order to be able to determine appropriate values for the impedances Z1 and Z2.

The neutralizing system may comprise other pairs of neutralizing devices to take into account other sources of leakage currents.

The neutralizing system may also be adapted to a multiphase system. In this case, one pair of neutralizing devices is employed for each pair of connectors connected to each source of leakage currents.

The leakage currents from a member of a motor vehicle connected to a power supply network 1 by a ground, and by at least one phase different from the ground, are neutralized by applying a neutralizing method during which a part of the voltage applied to the member is tapped, the tapped voltage is phase-shifted, and it is converted into neutralizing current. The amplitude of the neutralizing current is modulated in order to correspond to the amplitude of the leakage current.

To modulate the amplitude of the neutralizing current, the phase-shifted, tapped voltage is applied to an impedance whose value and nature correspond to those of the equivalent common-mode impedance that exists between the member and the exposed conductive structure of the vehicle, the equivalent common-mode impedance being previously determined.

The neutralizing method and system make it possible to neutralize the high-frequency leakage currents emanating from a member of a motor vehicle. They make it possible to neutralize, without differentiation, the leakage currents generated upstream and downstream of the member.

1-6. (canceled)

7. A system for neutralizing a high-frequency leakage current emanating from at least one member of a motor vehicle, connected to a power supply network via a rectifying device, the power supply network having a ground, and at least one phase different from the ground, the system comprising, for each member:
a first neutralizing device connected to rectified phases emanating from the rectifying device upstream of the member and to an exposed conductive structure of the motor vehicle, and/or
a second neutralizing device connected to rectified phases downstream of the member and to the exposed conductive structure,
the neutralizing devices configured to tap a part of the voltage applied to the member and to send into the exposed conductive structure a neutralizing current of same amplitude, of same direction, and of a phase opposite the leakage current.

8. The neutralizing system as claimed in claim 7, wherein the neutralizing device comprises a transformer with a first winding linked to the member and to a first plate of a capacitor, a second plate of the capacitor being linked to the ground, the second winding of the transformer is linked to the ground and to a first terminal of an impedance, a second terminal of the impedance being linked to the exposed conductive structure.

9. The neutralizing system as claimed in claim 8, wherein the impedance of the neutralizing device is substantially equal to the impedance between the member and the exposed conductive structure.

10. The neutralizing system as claimed in claim 7, wherein a neutralizing device downstream of a first member is common with a neutralizing device upstream of a second member.

11. A method for neutralizing a high-frequency leakage current emanating from at least one member of a motor vehicle, connected to a power supply network via a rectifying device, the power supply network having a ground, and at least one phase different from the ground, the method comprising:
generating, on an exposed conductive structure of the motor vehicle, a neutralizing current of same amplitude, of same direction, and of a phase opposite the leakage current.

12. The method as claimed in claim 11, wherein
a part of the voltage applied to the member is tapped,
the tapped voltage is phase-shifted, and
the tapped voltage is converted into neutralizing current of the same amplitude, of the same direction, and of a phase opposite the leakage current.
